(19) United States
(12) Patent Application Publication
(10) Pub. No.: US 2008/0133500 A1
(43) Pub. Date: Jun. 5, 2008

(54) Website evaluation and recommendation tool

(75) Inventors: Joshua Charles Edwards, Washington, IL (US); Jamie Marie Lang, Cambridge, IL (US); Jillian J. Wille, Normal, IL (US); Neil Miles Larimore, Peoria, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/605,971

(22) Filed: Nov. 30, 2006

(51) Int. Cl. G06F 17/30

(52) U.S. Cl. 707/5; 707/E17.108

(57) ABSTRACT

A computer system for a website evaluation and recommendation tool is provided. The computer system has a platform, at least one input device, and a central processing unit in communication with the platform and the at least one input device. The central processing unit is configured to access a website and evaluate the website by assigning scores to a plurality of weighted criteria. The central processing unit may also be configured to generate an evaluation score for the website from the scores and determine whether the evaluation score meets a pre-defined standard. The central processing unit may further be configured to recommend changes to the website based on the evaluation score and the pre-defined standard.

### TECHNICAL FIELD

The present disclosure is directed to the field of website development and, more particularly, to a website evaluation and recommendation tool.

### BACKGROUND

Companies seek to provide customers with information on products and services in a reliable, user-friendly manner. For example, many companies offer a website to customers that describes products, services, contact information, and other information of interest to customers. Companies can control the development of their website by hiring employees or contracting with a website developer to design a website according to the companies own specifications. Some companies, however, utilize independent dealers to sell and deliver products and services to customers. Each independent dealer may design a website to their unique preferences. Customers often associate the dealer's website with the website of the parent company, even though the dealer owns and operates their website independent of the parent company. As a result, the parent company cannot ensure that customers obtain information about their products and services in a reliable, user-friendly manner because the parent company does not control delivery of information through independent dealer websites.

Companies therefore would like some control over the development and maintenance of dealer websites. For example, companies may want the dealer website to use a common color scheme that represents the corporate logo of the company. Companies also would like a tool for evaluating dealer websites and generating recommendations for improvements to the dealer websites. By evaluating and recommending changes to dealer websites, a company may ensure reliable, user-friendly presentation of information about their products and services to customers.

One tool that has been developed for evaluating performance of a website is U.S. Patent Application Publication No. 2004/0176992 A1 by Santos et al. (the '992 publication). The '992 publication describes a method for evaluating performance of a website and generating a rating for the website. An agent may interact with a website using a behavior model and collect performance data, such as a website response time, product and service availability, and ease of use. The performance data may then be used to generate a performance rating for the website that customers can view.

Although the tool of the '992 publication may evaluate websites, the evaluation occurs irrespective of compliance with another website. For example, the '992 publication does not compare design standards of the website being evaluated to the design standards of a website offered by a parent company. Accordingly, the '992 publication does not ensure that customers receive information regarding products and services in a consistent manner. Rather, the '992 publication focuses on a behavior model designed around a model customer. The ranking is provided to a customer, and the customer may choose to not use the website. The '992 publication, however, does not generate recommended changes to a website having a low ranking. As a result, websites having a low ranking are neither improved nor updated to maintain consistency between a parent company's website and a dealer website. The risk therefore remains that a customer will not receive consistent information regarding products and services.

The present disclosure is directed to overcoming one or more of the problems set forth above.

### SUMMARY OF THE INVENTION

In accordance with one aspect, the present disclosure is directed toward a computer readable medium, tangibly embodied, including a website evaluation and recommendation tool. The computer readable medium includes instructions for accessing a website and evaluating the website by assigning scores to a plurality of weighted criteria. The computer readable medium also includes instructions for generating an evaluation score for the website from the scores and determining whether the evaluation score meets a pre-defined standard. The computer readable medium further includes instructions for recommending changes to the website based on the evaluation score and the pre-defined standard.

According to another aspect, the present disclosure is directed toward a method for providing a website evaluation and recommendation tool. The method includes accessing a website and evaluating the website by assigning scores to a plurality of weighted criteria. The method also includes generating an evaluation score for the website from the scores and determining whether the evaluation score meets a pre-defined standard. The method further includes recommending changes to the website based on the evaluation score and the pre-defined standard.

According to another aspect, the present disclosure is directed to a computer system including a platform, at least one input device, and a central processing unit in communication with the platform and the at least one input device. The central processing unit may be configured to access a website and evaluate the website by assigning scores to a plurality of weighted criteria. The central processing unit may also be configured to generate an evaluation score for the website from the scores and determine whether the evaluation score meets a pre-defined standard. The central processing unit may further be configured to recommend changes to the website based on the evaluation score and the pre-defined standard.

### BRIEF DESCRIPTION OF THE DRAWINGS

FIG. 1 is a block illustration of an exemplary disclosed website evaluation and recommendation system;

FIG. 2 is a flowchart illustration of an exemplary disclosed method of evaluating websites and recommending changes to the websites; and

FIG. 3 is a schematic illustration of an exemplary disclosed website evaluation and recommendation report.

### DETAILED DESCRIPTION

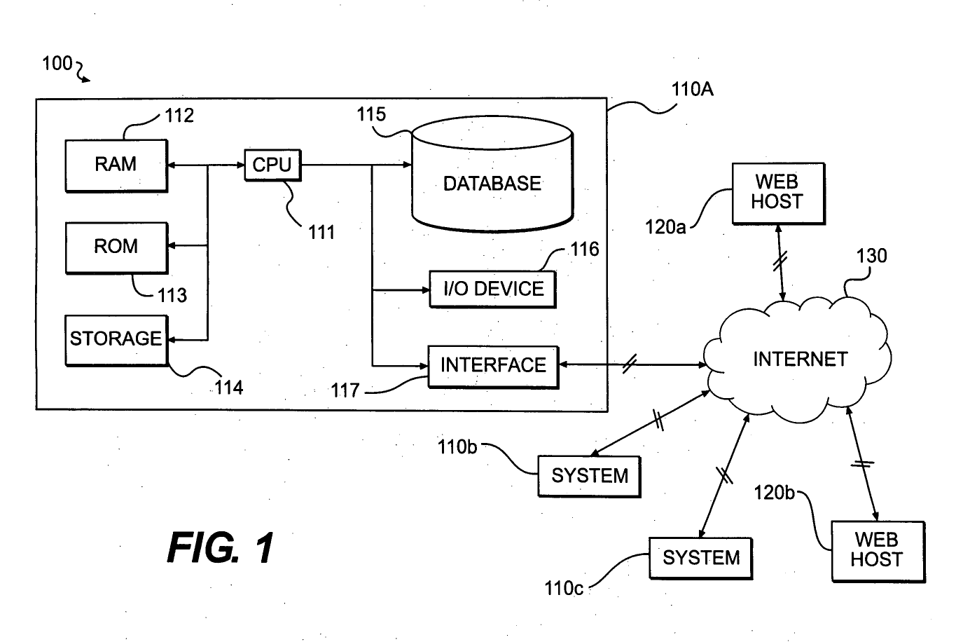

FIG. 1 provides a block diagram illustrating an exemplary disclosed website environment 100. Website environment 100 may include any type of environment associated with developing, distributing, evaluating, updating, and maintaining websites.

Website environment 100 may include a plurality of systems 110a-c. Customers may use systems 110a-c to access websites provided by web hosts 120a-b over Internet 130. Systems 110a-c may also evaluate websites provided by web hosts 120a-b and generate recommended improvements or changes for the websites.

Systems 110a-c may include any type of processor-based system on which processes and methods consistent with the disclosed embodiments may be implemented. For example, as illustrated in FIG. 1, system 110a may include one or more hardware and/or software components configured to execute software programs. System 110a may include one or more hardware components such as a central processing unit (CPU) 111, a random access memory (RAM) module 112, a read-only memory (ROM) module 113, a storage 114, a database 115, one or more input/output (I/O) devices 116, and an interface 117. System 110a may include one or more software components such as a computer-readable medium including computer-executable instructions for performing methods consistent with certain disclosed embodiments. One or more of the hardware components listed above may be implemented using software. For example, storage 114 may include a software partition associated with one or more other hardware components of system 110. System 110 may include additional, fewer, and/or different components than those listed above, as the components listed above are exemplary only and not intended to be limiting.

CPU 111 may include one or more processors, each configured to execute instructions and process data to perform one or more functions associated with system 110. As illustrated in FIG. 1, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of system 110a and CPU 111. RAM 112 may include a memory device for storing data associated with one or more operations of CPU 111. For example, ROM 113 may load instructions into RAM 112 for execution by CPU 111. ROM 113 may include a memory device configured to access and store information associated with system 110a, including information for identifying, initializing, and monitoring the operation of one or more components and subsystems of system 110a.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by system 110a and CPU 111. For example, database 115 may include historical data from evaluating websites, such as previous evaluation scores, recommended improvements, timelines for making the improvements, and customer surveys. CPU 111 may access the information stored in database 115 for comparing the past recommended website improvements to the current state of a website.

I/O devices 116 may include one or more components configured to communicate information with a user associated with system 110a. For example, I/O devices may include a console with an integrated keyboard and mouse to allow a user to input parameters associated with system 110. I/O devices 116 may also include a display, such as a monitor, including a graphical user interface (GUI) for outputting information. I/O devices 116 may also include peripheral devices such as, for example, a printer for printing information associated with system 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

The results of received data may be provided as output from system 110a to I/O device 116 for printed display, viewing, and/or further communication to other system devices. Such output may include, for example, evaluation reports, recommended changes to a website, required changes to a website, timelines for improving a website, and other data consistent with evaluating websites. Output from system 110a can also be provided to database 115 and to other systems 110b-c and web hosts 120a-b to track website evaluations. Using this information, websites may be evaluated and updated in a consistent manner, allowing a company to provide information on products and services to a customer in a consistent, user-friendly manner.

Interface 117 may include one or more components configured to transmit and receive data via a communication network, such as the Internet 130, a local area network, a workstation peer-to-peer network, a direct link network, a wireless network, or any other suitable communication platform. In this manner, systems 110a-c and web hosts 120a-b may communicate through the use of a network architecture. The network architecture may include, alone or in any suitable combination, a telephone-based network (such as a PBX or POTS), a local area network (LAN), a wide area network (WAN), a dedicated intranet, and/or the Internet 130. Further, the network architecture may include any suitable combination of wired and/or wireless components and systems. For example, interface 117 may include one or more modulators, demodulators, multiplexers, demultiplexers, network communication devices, wireless devices, antennas, modems, and any other type of device configured to enable data communication via a communication network.

A customer may use system 110a to access websites that provide information on products and services. In this embodiment, system 110a may be, for example, a personal computer. A company may also use system 110 to access, evaluate, and generate recommended and required improvements to a website. System 110a may monitor websites periodically or continuously to generate recommended changes and improvements to a website.

Web host 120a may provide one or more websites to systems 110a-c over Internet 130. For example, web host 120a may provide a website maintained by a dealer to systems 110a-c. Web host 120a may also provide a website maintained by a parent company to systems 110a-c. Web hosts 120a-b may contain similar software and hardware products as system 110a for storing and delivering websites to systems 110a-c.

Those skilled in the art will appreciate that all or part of systems and methods consistent with the present disclosure may be stored on or read from other computer-readable media. Website environment 100 may include a computer-readable medium having stored thereon machine executable instructions for performing, among other things, the methods disclosed herein. Exemplary computer readable media may include secondary storage devices, such as hard disks, floppy disks, and CD-ROM; a carrier wave tangibly embodied on a storage device; or other forms of computer-readable memory, such as read-only memory (ROM) 113 or random-access memory (RAM) 112. Such computer-readable media may be embodied by one or more components of website environment 100, such as systems 110a-c, web hosts 120a-b, or combinations of these and other components.

Furthermore, one skilled in the art will also realize that the processes illustrated in this description may be implemented in a variety of ways and include multiple other modules, programs, applications, scripts, processes, threads, or code sections that may all functionally interrelate with each other to accomplish the individual tasks described above for each module, script, and daemon. For example, these programs modules may be implemented using commercially available software tools, using custom object-oriented code written in the C++ programming language, using applets written in the Java programming language, or may be implemented as with discrete electrical components or as one or more hardwired application specific integrated circuits (ASIC) custom designed for this purpose.

The described implementation may include a particular network configuration but embodiments of the present disclosure may be implemented in a variety of data communication network environments using software, hardware, or a combination of hardware and software to provide the processing functions.

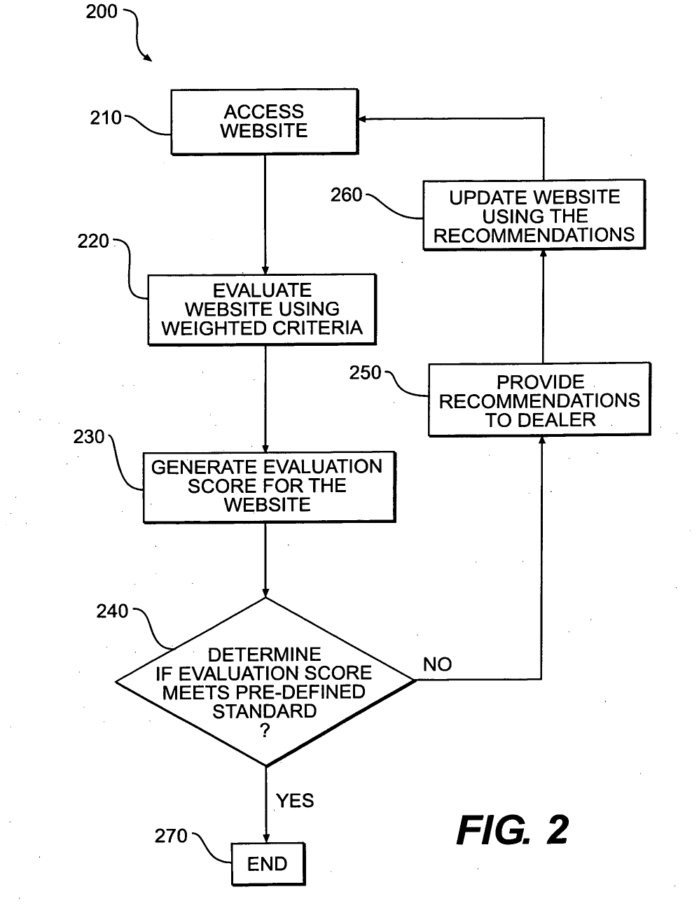

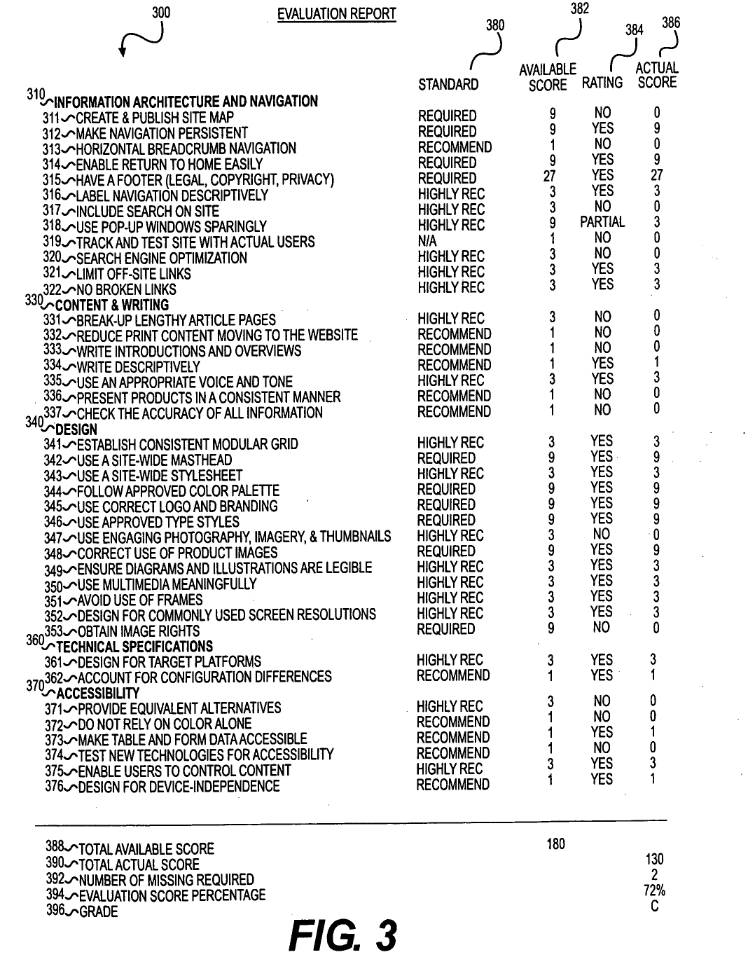

Processes and methods consistent with the disclosed embodiments may provide a website evaluation and recommendation tool that reduces the potential for losing customers due to lack of consistency between independent dealer websites and a parent company. As a result, dealer websites may be evaluated and updated, allowing a company to provide information on products and services to a customer in a consistent manner. Exemplary processes and methods will now be described with reference to FIGS. 2 and 3.

### INDUSTRIAL APPLICABILITY

The disclosed method and system may provide a website evaluation and recommendation tool. In particular, the disclosed method and system may be used to implement a website evaluation and recommendation tool that uses a plurality of weighted criteria to evaluate a website. Scores may be assigned to the weighted criteria depending on whether and to what extent a website complies with the criteria. An evaluation score for the website may be generated from the scores for the weighted criteria. Recommendations for improvements to a website may be provided to the owner of the website based on the weighted criteria and based on the evaluation score. In this manner, websites may be updated to provide information on products and services to a customer in consistent manner.

FIG. 2 illustrates an exemplary method 200 for a website evaluation and recommendation tool. The first step in the functioning of the website evaluation and recommendation tool may include accessing a website (Step 210). For example, a user at one of systems 110a-c may access a website provided by web hosts 120a-b through Internet 130. The website may be, for example, a website of a dealer. The user may be, for example, an employee of a parent company of the dealer, a user of the dealer, an employee of a third party company, or a customer of the dealer or parent company.

After accessing the website, the user may evaluate the website using a plurality of weighted criteria (Step 220). The criteria may be divided into a one or more categories that a parent company uses for evaluating dealer websites. Each criteria may be weighted based on the importance of the criteria to the parent company in establishing consistent delivery of information. A user may navigate through the website to determine a score for each weighted criteria. For example, if a criteria for the website is providing a search function, the user may determine whether the website has a search function. Websites may also be evaluated using an automated process that accesses the source code of a website, such as hyper-text markup language (html), and determines whether the website provides the functionality defined by the criteria. Examples of the weighted criteria and categories will be described with reference to FIG. 3 below.

After assigning a score to each weighted criteria, system 110a may generate an evaluation score for the website (Step 230). The evaluation score may be a sum of the scores for each of the weighted criteria. The evaluation score may be scaled to generate an assessment result, such as a letter grade for the website, as described in more detail below with reference to FIG. 3.

System 110a may then determine if the evaluation score meets a pre-defined standard (Step 240). A parent company that evaluates the website may specify that a dealer website achieve a pre-defined standard to avoid updating the website. For example, the parent company may specify that the dealer website comply with at least 85% of the weighted criteria. In addition, the parent company may specify that the dealer website meet all required criteria regardless of the overall evaluation score. A required criteria may be a criteria that the website must comply with in order to meet the pre-defined standard (FIG. 2, Step 240) of the parent company that evaluates the website. If the website does not meet all required criteria, the parent company may require that independent dealer update their website to be in full compliance with the required criteria. However, the parent company may also accept a dealer website that fails to comply with a certain number of required criteria, such as three. An example of determining whether a website meets a pre-defined standard will be provided with reference to FIG. 3.

If the evaluation score does not meet the pre-defined standard of the parent company, a user of system 110a may provide the evaluation score and recommended website changes to the dealer (Step 250). The evaluation score and recommended website changes may be provided via telephone, e-mail, or any other transmission over Internet 130 to a system owned by the dealer, such as system 110b. The recommendations may include adding content to the website, removing content from the website, and changing content in the website. These recommendations may be formatted in a table that describes each criteria, defines the weight associated with the criteria, provides a score for each weighted criteria, and provides other information regarding the website evaluation, as described below with reference to FIG. 3. The recommendations may include only the suggested improvements to a dealer's website, an evaluation for all of the criteria on the dealers website, or any combination thereof.

The parent company may specify that required or recommended changes to the dealer website occur within a certain period of time. For example, the parent company may allow one week for a dealer to change their website to correct serious errors (e.g., incorrect branding) and four weeks to allow a dealer to correct minor errors (e.g., typographical errors). If the dealer does not comply within the period of time, the parent company may withhold supplying the dealer with products or services for sale to customers. In this manner, the parent company may ensure that the dealer quickly updates their website such that customers receive information regarding products and services in a consistent manner.

The dealer may then update the website using the recommendations (Step 260) to meet the pre-defined standard. The dealer may choose to implement only a subset of the recommended website changes to save costs associated with website development. The dealer may perform the changes on their own or using a third-party website development company. Once the dealer updates the website, the parent company may access the website, such as using computer 110a, and re-evaluate the website as described above. This process may continue until the dealer website meets the pre-defined standard provided by the parent company.

If the evaluation score meets the pre-defined standard of the parent company in Step 240, the dealer's website may continue to operate without change (Step 270). Optionally, the parent company may provide the evaluation report to the independent dealer including recommended changes, but the independent dealer need not update the website when the evaluation score meets the pre-defined standard. A parent company may continue to monitor and evaluate, periodically or on demand, the dealer website using systems 110a-c. Continued monitoring and evaluation of dealer websites may ensure that a dealer does not update, or fail to update, their website in a manner that lowers the evaluation score below the pre-defined standard. The parent company may also develop new criteria or change the weight of criteria, either of which may require a new evaluation of the dealer website.

FIG. 3 illustrates an exemplary website evaluation and recommendation report 300. Users may evaluate a website using, for example, system 110a, and generate, view, save, and print a website evaluation report 300, which may be provided in any format, such as an Excel® spreadsheet. Evaluation report 300 may, for example, identify the importance of the criteria used to evaluate the website, provide an overall evaluation score for the website, and identify recommended changes to the website.

Evaluation report 300 may include a plurality of criteria for evaluating a website. The criteria may be divided into one or more categories, such as information architecture and navigation 310, content and writing 330, design 340, technical specifications 360, and accessibility 370, although additional categories and criteria may be used.

Each criteria may have an associated standard 380 for weighting the criteria. The parent company or user evaluating a website may define the standards for each criteria based on, for example, experience and feedback from customers. The standards for each criteria may also be defined based on the importance of maintaining consistency with the parent company and dealer website. Exemplary standards 380 include “recommended,” “highly recommended,” and “required.” Although three exemplary standards have been described for evaluating criteria of a website, additional standards may be used with varying weights.

An available score 382 may be the total available score for a criteria that a website may obtain if the website fully complies with the criteria. Available score 382 may be weighted based on the standard for the criteria. For example, recommended criteria may have an available score 382 of one, highly recommended criteria may have an available score 382 of three, and required criteria may have an available score 382 of nine. Each criteria may also receive a unique weighting based on the importance of the criteria in evaluating the website. For example, the criteria “have a footer” 315 may have an available score 382 of 27 because legal, copyright, and privacy disclaimers may be required by law.

Rating 384 may describe whether the website conforms with the standard 380 for each criteria. Exemplary ratings 384 include no (if the website does not comply with the criteria), partial (if the website partially complies with the criteria), and yes (if the website fully complies with the criteria). Ratings 384 may be used to determine the actual score that a website receives for a given criteria, as described below. Although three exemplary ratings 384 have been described, additional ratings 384 may be used to evaluate websites. Ratings 384 may provide feedback to the dealer so that the dealer can quickly identify ways to improve the website.

Actual score 386 may be the number of points that a website receives for each weighted criteria out of available score 382. Actual score 386 may be zero if a website does not comply with a criteria, a portion of available score 382 if the website partially complies with a criteria, or equal to available score 382 (e.g., a full score) if the website fully complies with the criteria. For example, if a website fully complies with a required criteria “make navigation persistent” 312 having an available score 382 of nine points, then the website may receive an actual score 386 of nine points for that criteria. Further examples of actual scores 386 will be described in more detail below.

Total available score 388 may be the sum of available scores 382 for the criteria. Total actual score 390 may be the sum of actual scores 386 for the criteria. An evaluation score percentage 394 may be computed by dividing total actual score 390 by total available score 388. Evaluation score percentage 394 may identify the overall compliance of a website with the standards of the evaluating company. Evaluation score percentage 394 may establish a pre-defined standard for compliance. For example, a pre-defined standard may be that the website achieves an evaluation score percentage 394 of at least 80%. Therefore, an evaluation score percentage below 80% may result in the website failing to meet the pre-defined standard (FIG. 2, Step 240). The website may receive a grade 396 using evaluation score percentage 394. For example, an evaluation score percentage 394 from 90-100% may receive a grade 396 of “A”; an evaluation score percentage 394 from 80-89% may receive a grade 396 of “B”; an evaluation score percentage 394 from 70-79% may receive a grade 396 of “C”; an evaluation score percentage 394 from 60-69% may receive a grade 396 of “D”; and an evaluation score percentage 394 below 60% may receive a grade 396 of “F”. While exemplary evaluation score percentages 394 and grades 396 have been described, the company or user evaluating the website may create a unique pre-defined standard and may define additional grades 396. Moreover, either total actual score 390 or evaluation score percentage 394 may be an evaluation score for the purposes of establishing a pre-defined standard.

The number of missing required 392 may be the number of criteria with a standard 380 of “required” that the website does not comply with. In the example illustrated in FIG. 3, the website being evaluated failed to comply with two required criteria-create and publish a site map 311 and obtain image rights 353. A dealer may use number of missing required 392 to quickly identify significant problems in the website design and implementation. The company evaluating the website may require that the number of missing required 392 be zero to meet the pre-defined standard. Thus, if a website fails to comply with one or more required criteria, the website must be redesigned or corrected. However, the parent company may also accept a dealer website that fails to comply with a certain number of required criteria, such as three.

Exemplary criteria for evaluating a website will now be described. A company or user may generate evaluation report 300 using the exemplary criteria as well as additional criteria. Criteria may be removed or modified as determined by the company or user evaluating the website. Criteria may also be sub-divided into more specific criteria. For example, a criteria for evaluating whether a website has a proper footer 315 may be divided into three separate criteria for evaluating whether the footer provides legal disclaimers, copyright disclaimers, and a privacy policy.

Information architecture and navigation category 310 may include a plurality of criteria 311-322. These criteria 311-322 may evaluate whether a website has good organization and usability. If a website provides information that a customer wants but the customer cannot find the information, the customer may become frustrated. Information architecture and navigation category 310 may ensure consistent, easy to use organization of the information on a website so that customers can quickly locate desired information.

A first criteria of information architecture and navigation 310 may be creating and publishing a site map 311. Site maps may group categories of information and help customers understand the relationship between these groups of information. Each category of information may be further grouped into sub-categories or directly into webpages. An exemplary category of information is “products,” with subcategories directed to backhoe loaders, front shovels, and scrapers. Additional exemplary categories and subcategories of information are services, including financing, training, and logistics; industries, including heavy construction, mining, and railway power; showcase, including customers, dealers, and success stories; and about, including news and events, investor information, and a summary of the parent company or a dealer. The site map may be a hierarchical structure, with the category and subcategory description serving as links to more information. The site map may be used to generate a navigation scheme, as described below. Because a site map provides a quick, easy way for customers to identify all of the information available on the website, this criteria may be required.

Another criteria may be making navigation of the website persistent 312 throughout the webpages on a website. Navigation may be a set of links that enable moving between webpages of a website. By using a common, persistent navigation scheme, customers may easily learn the structure of the website. Navigation may be divided into multiple levels, with each level of navigation maintaining a persistent and distinct organization. For example, a list of all categories may appear across a header of a webpage, and a drop down menu on the left side of the webpage may display the subcategories within the category a customer is currently viewing. The subcategory that a user is viewing may be highlighted (which may be a separate criteria). Additional techniques and criteria may be used to make navigation persistent across a website to ensure that customers can easily locate desired information. For example, criteria may evaluate whether navigation provides access to all webpages within a website, and ensure that navigation does not link to off-site webpages (as described below). Making navigation persistent 312 may be a required criteria with an available score 382 of nine points.

Another exemplary criteria is horizontal breadcrumb navigation 313, which may be a trail of links that the customer has clicked on. This trail of links may indicate to the customer the webpages a customer already visited, allowing the customer to quickly navigate back to a previous webpage without using the back feature commonly offered in Internet browsers. Horizontal breadcrumb navigation 313 may be implemented from left to right, with the first webpage that a customer visited appearing on the left and ending with the current webpage on the right. Horizontal breadcrumb navigation 313 may have a recommended standard 380 and an available score 382 of 1. In the example of FIG. 3, the website did not include horizontal breadcrumb navigation and therefore received an actual score of zero for this criteria.

Websites should also enable easy return to the homepage of the website 314. For example, a link to the homepage may be provided in a navigation menu on the left side of each webpage, in the header of each webpage, or in a footer of each webpage. The name of the dealer or parent company may also serve as a link to return to the homepage. As illustrated in FIG. 3, this link to the homepage may be a required criteria that a dealer must implement.

Another information architecture and navigation criteria is having a footer 315 at the bottom of every webpage on the website. The footer may include links to more information, such as links to legal disclaimers, copyright rules, and privacy policies, although additional links may be included within the footer. Because these disclaimers may be required by law and protect the interests of a parent company and dealer, a footer may be required and have a highly weighted available score 382, such as 27.

Another criteria is labeling navigation descriptively 316. Customers expect navigation links to be labeled intuitively and descriptively to clearly identify the linked information. The navigation description should include just a few words to ensure that customers can quickly identify whether the link interests them. Moreover, the navigation links that appear throughout the webpages should be kept consistent. For example, if a first webpage provides a link to “products” with a sub-category of “machines,” other webpages in the website should similarly use the same links and descriptions. When a customer selects the link to “machines,” the webpage should be clearly labeled as “Machines” to confirm to a customer that they selected the desired webpage. In addition, navigation options should be grouped in a reasonable number, such as seven primary categories of information. The grouping of navigation options may be scored within the criteria of labeling navigation, or may be a separate criteria. Labeling navigation descriptively 316 may be a highly recommended criteria with an available score 382 of three points.

Websites should also include a search on the website 317. The search function may be an open text field that customers can type queries into for searching all of the webpages included in the website. The queries can be traced and recorded to improve search results and to provide information that customers frequently search for in a more prominent manner. Inclusion of a search may have a different standard 380 and available score 382 depending on the size of the website being evaluated. For example, a simple website including only a single webpage may not need a search, whereas a website including a hundred webpages may require a search. In the example of FIG. 3, the website being evaluated did not have a search and therefore received an actual score of zero points out of an available three points.

Websites may also be evaluated to determine if the website uses pop-up windows sparingly 318. Websites should minimize use of pop-up windows by presenting links and content in the main Internet browser. A website may use pop-up windows, however, in some situations to open a new Internet browser window for a special type of content, such as an Adobe® PDF file. The user or company evaluating a website may also define other situations where use of a pop-up window may be allowed, such as for help content, photos or movie trailers, or glossary definitions. As illustrated in FIG. 3, although the available score for use of pop-up windows sparingly 318 is nine, the actual score is only three. This indicates to the dealer that their website uses pop-up windows in some improper situations and is an example of awarding an actual score that is a partial amount of the available score for a weighted criteria.

Dealers should also track and test their website with actual users 319. Dealers may track their website by analyzing website traffic using, for example, cookies. A dealer may use cookies to determine an average duration that a customer spends on the website, the average number of webpages a customer visits, the search terms used in an Internet search to find the website, and other categories in evaluation report 300, such as whether the customer selected a broken link. Dealers may also track the most and least requested downloads from the website, most and least frequently visited webpages, where customers live, the type of systems 110a that customers use, and technical performance of the website, such as the number of webpages requested per day, hour, week, or other period of time.

Dealers may test their website by asking customers to provide feedback on the website, such as the website's usability and organization. Dealers may also test their website to ensure that the website can handle a sufficient volume of traffic without slowing down the transfer of information to customers. Although described as a single evaluation criteria, tracking and testing a website 319 may be separated into two or more criteria. Tracking and testing a website with actual users 319 may have a standard 380 of “N/A” to indicate that the website was published prior to implementation of weighted criteria. Once the company informs the dealer of the need to track and test their website, this criteria may have a standard 380 of recommended.

Dealers should also optimize their website for search engine results 320. Customers may search for information on products and services using an Internet search engine, such as Yahoo!® or Google®. By optimizing websites for search engine results, companies can ensure that their website and the websites of their dealers will appear at or near the top of the results for a search of their products. Dealers may optimize their website for search engines by, for example, using keywords, using descriptive uniform resource locators (URLs), using descriptive headers, using HTML meta keywords and descriptions, linking with other websites, and updating the content of the website frequently. Restrictions may be placed on the use of these optimization techniques, such as hiding text designed for search engine results that should not be displayed to customers. Additional methods and techniques may be used to optimize search engine results. Search engine optimization 320 may be a highly recommended criteria with an available score 382 of three points.

Another evaluation criteria is limiting off-site links 321. An off-site link may be a link outside the dealer website that the dealer does not control. Off-site links should be limited because a customer that selects an off-site link may not return to the dealer website, and the opportunity to attract the customer's business may therefore be lost. In addition, off-site links may change or be removed without notice to the dealer. As a result, when a customer selects an off-site link that no longer works, the customer may associate this negative perception with the dealer and parent company. When dealers do use off-site links, the links should provide information that is closely tied to the dealer website, such as reviews of products that the dealer sells. A dealer website may use off-site links to other dealers of the same product or to the parent company's website, however, without losing points in actual score 386. Limiting off-site links 321 may have a standard 380 of a highly recommended and, in the example of FIG. 3, receive a full actual score of three points for full compliance.

Websites should avoid broken links 322. Broken links include links that do not work or links to an “under construction” webpage. These links should be removed from a website because a customer will expect that they contain content. Sometimes a webpage may contain information that, although not complete, may be important to a customer. In this situation, the webpage may maintain those links. For example, a webpage may allow a user to order a product, but the product may be out of stock. Although a customer cannot use the webpage as expected, the webpage should be maintained and a notice should be displayed that the product is out of stock. Avoiding broken links 322 may have a standard 380 of highly recommended and an actual score 382 of three points.

Content and writing category 330 may evaluate the appearance of the website using criteria 331-337. Customers may associate dealer websites with the parent company, so the appearance of a dealer website should not only be consistent within the dealer website, but also consistent with the appearance of the parent company's website.

One exemplary content and writing criteria for evaluating websites is breaking up lengthy article pages 331. Websites should use organized, short, and easy to read articles. For example, articles may be divided into sections using headers with only a few paragraphs in each section. The paragraphs may be limited to a few lines per paragraph so that a customer can quickly skim the content of the article. The articles may also use other methods of organization, such as providing an introductory paragraph that explains the sections of article. Breaking up lengthy article pages 331 may have a standard 380 of highly recommended and an available score 383 of three points.

Websites should also reduce print content moving to the website 332. Before placing a white paper or other document on a website, the dealer should reduce the amount of content in that document. Customers viewing a website often want to skim an article to obtain the key points of the article. Dealers should therefore reduce a large print document to an article that can be easily scanned on a webpage. The dealer website may provide a link to the full document so that customers who want the full amount of detail can obtain it. As an example of reducing content, the dealer may reduce most documents to half of their original length prior to posting the document on their website. Of course, other reductions can be used as appropriate for the document. Reducing print content moving to the website 332 may have a standard 380 of recommended and an available score 382 of one point.

Websites should also write introductions and overviews 333 for webpages, particularly for upper level pages. Introductions and overviews inform customers about the main topic and points of information on a given webpage. Websites may also provide introduction and overviews to explain the relationship between a group of links and the relevancy of a group of links to an article. Writing introductions and overviews 333 may have a standard 380 of recommended and an available score 382 of one point.

Another content and writing criteria is writing descriptively 334. For example, articles should include a descriptive title at the top of the webpage. The title can provide clues to customers to ensure that the desired webpage is displayed. The title may match with the original navigation link description and explain what the article discusses. The title, as well as the content of the article, should avoid j argon or other terms that may be unfamiliar to a customer. For example, dealers should define acronyms in the first reference or avoid the use of acronyms. Writing descriptively 334 may have a standard 380 of recommended and an available score 382 of one point.

Websites should also use an appropriate voice and tone 335. As discussed above, customers often associate dealer websites with the parent company. Therefore, the dealer websites should use a voice and tone that is consistent with the parent company. For example, the tone should be personable, customer-focused, engaging, professional, and should consistently represent the corporate brand. A parent company or user evaluating a dealer website may define additional factors or themes depending on, for example, the marketing of the parent company. Using an appropriate voice and tone 335 may have a standard 380 of highly recommended and an available score 382 of three points.

Websites should also present products in a consistent manner 336. Customers may visit dealer websites and the parent company's website to obtain information regarding products or services. The dealer websites should provide similar information to the parent company, such as a model number, short description, and detailed features for products that the dealer sells. The dealer websites should also ensure that their information is accurate. Product descriptions may change, such as when the parent company releases an updated model for a new year. The dealer website may reflect updated product descriptions, including new features in updated models. Presenting products in a consistent manner 336 may have a standard 380 of recommended and an available score 382 of one point.

Another content and writing criteria is whether the dealer checks the accuracy of all information 337 provided on the website. Because web content can become quickly outdated, the dealer should track the content of their website, particularly content with a short lifespan. An example of content with a short lifespan is an article describing a newly released product. After a certain period of time, such as a few months, the article should be removed and the product should be described as a regular product offering. When describing products or services, the dealer should use the most up to date corporate communication materials from the parent company. The dealer should also review the webpage for typographical errors before posting a new webpage to a dealer website. In addition, a dealer should present information in languages that customers are likely to understand, and dealers should check the accuracy of translating information into those languages. The determination of whether a dealer checks the accuracy of information may be made by evaluating the website to see if errors exist and by receiving reports from the dealer demonstrating that the dealer conducted a review. Dealer websites may be required to submit updated webpages on product offerings to the parent company for review prior to publishing the updated webpages. Checking the accuracy of all information 337 may have a standard 380 of recommended and an available score 382 of one point.

Design category 340 may provide branding standards for dealer websites. Although dealer websites should maintain a consistent theme with the website of the parent company, dealers may retain some control over the presentation of content on their websites. Design category 340 may therefore evaluate whether the incorporation of both the dealer's own design decisions and the design of the parent company's website are consistent enough that customers will associate the two in a positive manner.

For example, one design criteria is whether the dealer establishes a consistent modular grid 341. A modular grid may be a template that is consistent between webpages. A template may include a header, drop down menus on the left side of the webpages, and other columns of relevant information. The modular grid should be designed in a simple manner because ornate webpages may confuse consumers. The parent company may specify a general framework for creating a modular grid, which the dealer may then modify to suit their own needs. Establishing a consistent modular grid 341 may have a standard 380 of highly recommended and an available score 382 of three points.

Another design criteria may be use of a site-wide masthead 342. A site-wide masthead may include, for example, links to primary navigation, a link to the homepage for the website, a link to contact information, and a search function. The masthead may identify the name of the dealer as well as the parent company. The masthead may be placed in the same position for all of the webpages within the dealer website to confirm to customers that they are still on a dealer webpage. Use of a site-wide masthead 342 may have a standard 380 of required and an available score 382 of nine points.

Dealers should also use a site-wide style sheet 343. Style sheets may provide uniformity to the visual style and re-enforce the overall brand of the dealer and parent company. For example, the style sheet may use consistent font sizes, colors, linking styles, and other typography techniques that are consistent throughout the website. Using a site-wide style sheet 343 may have a standard 380 of highly recommended and an available score 382 of three points. Use of a site-wide style sheet 343 may have a standard 380 of highly recommended and an available score 382 of three points.

Another design criteria is following an approved color palette 344. Customers may associate the parent company with certain color schemes that the parent company uses to promote products. Therefore, dealer websites should use the color palette for the parent company to confirm to customers that they are viewing an official dealer website of the parent company. For example, backgrounds in the masthead of a website should use the official colors of the parent company. Due to the importance of color-product association, use of the approved color palette may be required, and use of colors outside of the palette may be prohibited. In the example of FIG. 3, the website fully complied with the approved color palette and therefore received a full actual score of nine points.

Similar to the color palette, a dealer website should use correct logos and site branding 345 to confirm to customers that they are viewing an official dealer website of the parent company. The logo may be placed at the top of every webpage in the dealer website, such as in the site-wide masthead. However, the logo should not be over-used, as this may become distracting to customers. Correct use of logos and site branding 345 may have a standard 380 of required and an available score 382 of nine points.

Dealer websites should also use approved type styles 346. The parent company may define the font that dealer websites should use in order to maintain consistency between dealer websites and the parent company's website. For example, a dealer may be required to use left justified Sans Serif font. The parent company or user evaluating the website may also require that the font not be condensed, as this may increase the difficulty of reading the website. Additional type styles may also be defined by the parent company, such as using bulleted lists with a default bullet style. Use of approved type styles 342 may have a standard 380 of required and an available score 382 of nine points.

Dealer websites should also use engaging photography, imagery, and thumbnails 347. Photography should give the customer a sense of the overall products and company, focusing not only on the products but also on the people that create and use the products. The selected photographs should identify the parent company, such as by having a product logo in clear view. The photographs should be simple (e.g., use only a single product or person) because webpage photography may be small images. For example, close-up pictures of a single product with a clean background may be easier for customers to view than a picture from far away. The images may be optimized for fast downloading, such as JPG files for photographs or GIF files for graphics. Websites should also use thumbnails to preview large images. Thumbnails may allow a small image to load faster while giving the customer an option to view the full image. For example, a thumbnail image that links to a full image may be placed beside a product description. Although described as a single criteria, the use of engaging photography, fast-loading images, and thumbnails may be one or more separate design criteria for evaluating dealer websites. Use of engaging photography, imagery, and thumbnails may have a standard 380 of highly recommended and an available score 382 of three points.

Dealers should also ensure correct use of product images 348. For example, if a webpage provides information regarding a 135H Global Motor Grader, a thumbnail or full-size image of a product on that webpage should also be a 135H Global Motor Grader. If the image of a product does not match the other information on a webpage, customers may become confused about what product the webpage describes. In order to avoid this confusion, correct use of product images 348 may be required. Correct use of product images 348 may have a standard 380 of required and an available score 382 of nine points.

Another exemplary design criteria is ensuring legibility of diagrams and illustrations 349. Illustrations should focus on the detail of a product and should be clearly labeled. For example, an illustration of an asphalt paver should clearly illustrate the overall length, height, and width of the paver. Dealers should use illustrations with care, such as icons that may have different meanings depending on the culture or country in which they are viewed. Ensuring legibility of diagrams and illustrations 349 may have a standard 380 of highly recommended and an available score of three points.

Dealer websites should also use multimedia meaningfully 350, e.g., only when video, animation, or audio will help convey or support the content of a website. Multimedia may attract the attention of customers, but may also slow access time for a webpage. In addition to limiting the use of multimedia, animations and video should be incorporated into the webpage, rather than launched as a separate pop-up window. Using multimedia meaningfully 350 may have a standard 380 of highly recommended and an available score of three points.

Another exemplary design criteria is avoiding use of frames 351. Frames may divide a webpage into multiple parts and cause problems when a user wants to print a webpage. Accordingly, dealers should avoid the use of frames in their website. Avoiding use of frames 351 may have a standard 380 of highly recommended and an available score of three points.

Dealers should also design websites for commonly used screen resolutions 352. For example, dealers may design websites for 800×600 resolution, although other resolutions may be used. By designing for common screen resolutions, the dealers may ensure that customers can view the website in their Internet browser without having to scroll to view the content of a webpage. Designing for commonly used screen resolutions 352 may have a standard 380 of highly recommended and an available score of three points.

Another exemplary required design criteria is obtaining image rights 353. The use of images involves legal rights and, if used inappropriately, may expose the dealer and/or parent company to liability. In order to avoid these legal issues and ensure that the dealer does not violate copyright laws, dealer websites should never copy images from another website without obtaining image rights.

Another category of criteria is technical specifications 360. Technical specifications may ensure that dealer websites and applications will be compatible with a customer's system 110a-c.

One exemplary technical specification is designing for target platforms 361. Dealers should design, develop, and test their website for the most common operating system and Internet browser configurations, including available plug-ins such as Java® and Flash®. In addition, the website should be designed for common access speeds, such as a 56 k bandwidth modem or faster, to ensure that webpages will load quickly. Designing for target platforms 361 may have a standard 380 of highly recommended and an available score of three points.

Another exemplary technical specification is accounting for configuration differences 362 between customer systems. Although a majority of customers may use common target platforms, such as Microsoft Windows® operating system and Microsoft Internet Explorer®, other customers may use different operating systems and Internet browsers. These customers should have similar access to the website as customers using the target platforms. Accordingly, websites should be designed and tested in a manner that considers other platforms and configuration differences. Accounting for configuration differences 362 may have a standard 380 of recommended and an available score of one point.

Another exemplary category of criteria is accessibility 370. Accessibility criteria 370 ensure that the dealer website is useable and viewable by a large Internet audience. These guidelines may follow those available from the World Wide Web Consortium or any other industry standard for facilitating access to a website.

One exemplary accessibility criteria is providing equivalent alternatives 371. For example, a dealer website may provide text-only webpages as an alternative to full content webpages including video, audio, and animation. Text-only webpages may facilitate access to customers who use screen readers or other assistive devices. A dealer website may also provide text transcripts for audio and video content to ensure that customers using assistive devices have equal access to content available on the full webpages. Providing equivalent alternatives 371 may have a standard 380 of highly recommended and an available score of three points.

Dealer websites should also not rely on color alone 372. Some customers may be color blind or color deficient, particularly in the green portion of the color spectrum. In order to facilitate access for these customers, the website should avoid using color alone to convey information. Dealer websites should also ensure adequate contrast between content and background colors. Not relying on color alone 372 may have a standard 380 of recommended and an available score of one point.

Another accessibility criteria is making table and form data accessible 373. Information embedded in a table may be overlooked by visually impaired customers. These customers can better make use of information in a table by providing cues and guides regarding contents of the tables. For example, a dealer may provide row and column headers in each table on a webpage as well as summaries of tabulated information. Making table and form data accessible 373 may have a standard 380 of recommended and an available score of one point.

Dealer websites should also test new technologies for accessibility 374. Assistive devices that customers may use, such as devices that read text from a screen and produce audio output, may not adapt to new technologies and data formats quickly. For example, an assistive device that converts an audio file into text may not be able to interpret a new audio format. Therefore, the dealer website should update the text version of the webpage that has a transcription of the audio content. Testing new technologies for accessibility 374 may have a standard 380 of recommended and an available score of one point.

Another technical specification criteria is enabling customers to control content 375. For example, customers should be able to control the speed at which animated content plays. A fast-reading customer may want to speed up the rate of text moving across a screen, whereas a slow-reading customer may want to slow down this rate. Dealer websites can either allow the customers to control the playback speed of content or provide multiple versions of the content, each version using a different playback speed. Similarly, users should be able to control the size of file downloads. Dealer websites should segment large downloads into smaller divided files for customers that have a slower Internet connection and provide, for example, a single download file for customers that have a fast Internet connection. Enabling users to control content 375 may have a standard 380 of highly recommended and an available score of three points.

Dealers should also design their websites for device independence 376. For example, customers should be able to access content on a website without having to click a mouse because some customers may prefer to only use a keyboard for navigating webpages. Designing websites for device independence 376 may have a standard 380 of recommended and an available score of one point.

The criteria described herein are exemplary in nature. Parent companies and dealers may add, remove, or modify criteria based on the information provided by websites. Dealers and parent companies may also employ customer satisfaction surveys to improve websites. Examples of additional criteria include selecting an adequate Internet Service Provider (ISP) and storing information that a user enters (e.g., credit card information when making a purchase). Customers may also be informed of what will happen when they select a link. For example, customers may be informed if the link will navigate off the website, initiate a download, or open a non-web content file (e.g., an Adobe® PDF file).

While described as a parent company evaluating a dealer website, the dealer website may evaluate their own website and provide a report to the parent company. In addition, third parties may evaluate the dealer website. The parent company, dealer, and third parties may evaluate the websites prior to launching the website and periodically after launching the website to ensure continued compliance with the pre-defined standard. In the example of evaluation prior to launching the website, the parent company may provide a dealer with guidelines and recommendations for designing their website. In addition, a parent company may provide the dealer with HTML templates that can be used without modification, or may be customized by the dealer, to guide a dealer in the design of their website. By ensuring that a dealer's website complies with the standards of a parent company, the parent company can ensure consistent, user-friendly presentation of information to customers.

The disclosed website evaluation and recommendation tool ensures that customers will receive a consistent corporate image from a parent company and dealers of the parent company's products and services. As described herein, a parent company or a third party may evaluate a dealer website using a plurality of weighted criteria, assemble an actual score for the website, and generate recommendations and required changes to the website based on the evaluation. In this manner, the disclosed website evaluation and recommendation tool may provide use-friendly dealer websites and ensure consistent delivery of information to customers.

It will be apparent to those skilled in the art that various modifications and variations can be made to the disclosed methods for evaluating websites and generating recommendations for improving those websites. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A computer-readable medium, tangibly embodied, including a website evaluation and recommendation tool, the computer-readable medium comprising instructions for:
accessing a website;
evaluating the website by assigning scores to a plurality of weighted criteria;
generating an evaluation score for the website from the scores;
determining whether the evaluation score meets a pre-defined standard; and
recommending changes to the website based on the evaluation score and the pre-defined standard.

2. The computer-readable medium of claim 1, wherein:
a parent company completes the accessing, evaluating, generating, determining, and recommending, and a dealer of the parent company operates the website.

3. The computer-readable medium of claim 2, wherein the plurality of weighted criteria determine a consistency between a website operated by the parent company and the website operated by the dealer.

4. The computer-readable medium of claim 1, wherein the weighted criteria include required criteria.

5. The computer-readable medium of claim 1, further including instructions for dividing the weighted criteria into a plurality of categories.

6. The computer-readable medium of claim 1, further including instructions for generating an evaluation report for the website, the evaluation report including a list of the weighted criteria, the scores, a standard for each of the weighted criteria, and a rating for each of the weighted criteria.

7. The computer-readable medium of claim 1, further including instructions for:
updating the website based on the recommended changes;
accessing the website;
evaluating the website by assigning second scores to the plurality of weighted criteria;
generating a second evaluation score for the website from the second scores; and
determining whether the second evaluation score meets the pre-defined standard.

8. A method for providing a website evaluation and recommendation tool, comprising:
accessing a website;
evaluating the website by assigning scores to a plurality of weighted criteria;
generating an evaluation score for the website from the scores;
determining whether the evaluation score meets a pre-defined standard; and
recommending changes to the website based on the evaluation score and the pre-defined standard.

9. The method of claim 8, wherein:
a parent company completes the accessing, evaluating, generating, determining, and recommending, and a dealer of the parent company operates the website.

10. The method of claim 8, wherein the plurality of weighted criteria determine a consistency between a website operated by the parent company and the website operated by the dealer.

11. The method of claim 8, wherein the weighted criteria include required criteria.

12. The method of claim 8, further including dividing the weighted criteria into a plurality of categories.

13. The method of claim 8, further including generating an evaluation report for the website, the evaluation report including a list of the weighted criteria, the scores, a standard for each of the weighted criteria, and a rating for each of the weighted criteria.

14. The method of claim 8, further including:
updating the website based on the recommended changes;
accessing the website;
evaluating the website by assigning second scores to the plurality of weighted criteria;
generating a second evaluation score for the website from the second scores; and
determining whether the second evaluation score meets the pre-defined standard.

15. A computer system, comprising:
a platform;
at least one input device; and
a central processing unit in communication with the platform and the at least one input device, the central processing unit configured to:
access a website;
evaluate the website by assigning scores to a plurality of weighted criteria;
generate an evaluation score for the website from the scores;
determine whether the evaluation score meets a pre-defined standard; and
recommend changes to the website based on the evaluation score and the pre-defined standard.

16. The computer system of claim 15, wherein:
a parent company accesses, evaluates, generates, determines, and recommends,
a dealer of the parent company operates the website, and
the plurality of weighted criteria determine a consistency between a website operated by the parent company and the website operated by the dealer.

17. The computer system claim 15, wherein the weighted criteria include required criteria.

18. The computer system of claim 15, wherein the central processing unit is further configured to divide the weighted criteria into a plurality of categories.

19. The computer system of claim 15, wherein the central processing unit is further configured to generate an evaluation report for the website, the evaluation report including a list of the weighted criteria, the scores, a standard for each of the weighted criteria, and a rating for each of the weighted criteria.

20. The computer system of claim 15, wherein the central processing unit is further configured to:
update the website based on the recommended changes;
access the website;
evaluate the website by assigning second scores to the plurality of weighted criteria;
generate a second evaluation score for the website from the second scores; and
determine whether the second evaluation score meets the pre-defined standard.
